(19) United States
(12) Patent Application Publication
(10) Pub. No.: US 2005/0254486 A1
(43) Pub. Date: Nov. 17, 2005

(54) Multi processor implementation for signals requiring fast processing

(75) Inventors: Mohit Agarwal, Bangalore (IN); Amit Shaw, Bangalore (IN); Sreenath Ramanath, Bangalore (IN)

Correspondence Address: Global IP Services PLLC;C/o Portfolioip, P O Box - 52050, Minneapolis, MN, 55402, US

(73) Assignee: Ittiam Systems (P) Ltd.

(21) Appl. No.: 11/109,609

(22) Filed: Apr. 19, 2005

Related U.S. Application Data
(60) Provisional application No. 60/570,715, filed on May 13, 2004.

(51) Int. Cl. H04L 12/50

(52) U.S. Cl. 370/366

(57) ABSTRACT

In a signal processing method, a data signal (e.g., in a OFDM based wireless modem) containing symbols requiring fast processing, is divided into two symbol streams, e.g., streams containing odd and even numbered symbols, and, the two symbol streams are processed simultaneously in at least two relatively slower parallel-connected processors. The processed first and second streams are combined to provide a processed output signal in a given time interval. OFDM symbols that need to be processed within a short time interval as per IEEE standard 802.11a, may thus be handled on two parallel connected slower processors. Thus, processors that are unable to keep pace with the amount of processing each OFDM symbol requires, may be used with advantage. Several parallel/series configurations of processors, or processors with multiple internal execution paths may be used in the inventive method. A storage medium that can execute the inventive method is also described.

### RELATED APPLICATION

Benefit is claimed under 35 U.S.C.119 (e) to U.S. Provisional Application Ser. No. 60/570,715, entitled “Multiprocessor Implementation for OFDM based Wireless Modem” filed May 13, 2004, which is herein incorporated in its entirety by reference for all purposes.

### FILED OF THE INVENTION

This invention generally relates to parallel processing of data, and more particularly to method and apparatus using traditional parallel processors for processing data which has speed-requirements.

### BACKGROUND OF THE INVENTION

Communication technology has progressed by leaps and bounds because of new methods of design approach and innovations motivated by need. Broadband wireless access is the most challenging segment of the wireless revolution and has been demonstrated as a viable alternative to the cable modem and DSL technologies that are strongly entrenched in the communication environment. One widely accepted method of signal transmission is OFDM (orthogonal frequency division multiplexing). OFDM uses a method for multiplexing signals which divides the available bandwidth into a series of frequencies known as tones. OFDM access technology is based on transmission of data packets each of which consists of a number of OFDM symbols. A set of orthogonal sub-carriers together forms an OFDM symbol. Each OFDM symbol has a length of a known number of samples N and may carry a certain number of information bits or training data that might be used to assist the demodulator. An OFDM symbol is created by taking the DFT of N data symbols taken from a finite constellation comprising for example, BPSK (Binary Phase Shift Keying), QPSK (Quadrature Phase Shift Keying), QAM (Quadrature Amplitude Modulation), etc. Additional information regarding OFDM may be found in the publication: OFDM for Wireless Multimedia Communications, by Richard D J van Nee, Ramjee Prasad, published by Artech House. Further, in the WLAN (wireless local area network) system adopted by the IEEE 802.11 standard, each data packet consisting of a preamble and a data part. The preamble may consist of 10 short identical known OFDM symbols of length Ns=16, concatenated with 2 long identical and known OFDM symbols of length Nl=64, which may all be utilized for carrier correction, channel estimation, and synchronization. The data carrying part may consist of a variable number of OFDM symbols of length Nd=64. In one form, OFDM transmits one high-rate data stream over multiple parallel low-rate data streams.

In one OFDM transmission technique, complex data symbols may be coherently modulated on sub-carriers by an IDFT (inverse discrete Fourier transform) and a few last samples may be copied and put as a preamble (cyclic prefix) to form an OFDM symbol. OFDM based wireless modems have been traditionally implemented in FPGA or ASIC because of the large volume of signal processing requirements. Background information relating to parallel processors may be had from the publication: Computer Architecture, Pipelined and Parallel Processor Design, by Michael J Flynn, published by Jones and Bartlet Publishers. The use of traditional processors for OFDM applications has posed a challenge because of processing speed requirements.

### SUMMARY OF THE INVENTION

One embodiment of the invention resides in a method of processing data received as a signal comprising a set of symbols to be processed, where each said symbol needs, by design, to be processed in less than a first predetermined time interval, where, available processing means needs more than said first predetermined time interval to process each said symbol, said method comprising the steps of: dividing said set of symbols to be processed into a plurality of symbol groups; using parallel processing paths containing at least as many parallel paths as there are symbol groups; routing each said symbol group for processing, into one of said parallel processing paths; and, combining outputs from said parallel processing paths to form an output signal of processed data.

A second embodiment of the invention resides in a method of processing data in the form of a signal containing a set of symbols, where each said symbol needs to be processed in less than “n” microseconds, by design, where processing means that is available can process each said symbol in grater than “n” microseconds, said method comprising the steps of: dividing said signal for processing purposes into first and second streams, said first stream containing odd numbered symbols from said signal, said second stream containing even numbered symbols from said signal; using at least first and second processors connected in parallel, said first and second processors forming part of said processing means; processing said odd numbered symbols in said first processor, and simultaneously processing said even numbered symbols in said second processor; and, combining said processed odd and even numbered symbols to result in a processed data signal.

Another embodiment of the invention resides in an article comprising a storage medium having instructions thereon, which when executed by a computing platform result in a method as stated above. As an example, the method stated above and the article comprising the storage medium can be used in 802.11 WLAN applications.

Described hereinafter is a method and an article wherein, a data signal containing symbols that need fast processing, is divided into two symbol streams, e.g., streams containing odd and even numbered symbols, and, the two symbol streams are processed simultaneously in at least two relatively slower processors connected in parallel. The processed first and second streams are combined to provide a processed output in a given time interval. OFDM symbols that need to be processed within a short time interval as per IEEE standard 802.11a, may thus be handled on two parallel connected slower processors. Thus, processors that are unable to keep pace with the amount of processing that each OFDM symbol requires, may be used with advantage. Several parallel/series configurations of processors, or multiprocessor units, or processors with multiple internal execution paths may be used in the inventive method.

It is understood that modifications to the method and the article described herein are possible without departing from the thrust of the described invention, and are envisaged to be within the ambit of the present invention. It is also understood that acronyms used herein are to be understood as explained in the text unless they are otherwise known.

### BRIEF DESCRIPTION OF THE DRAWING

Embodiments of the invention will now be described by way of example only and not a limitation, with reference to the accompanying drawing wherein:

FIG. 1 illustrates one implementation showing traditional parallel processors handling an incoming signal;

FIG. 2 illustrates a second implementation showing parallel/series combinations of traditional processors handling an incoming signal;

FIG. 3 illustrates a third implementation showing series/parallel combinations of traditional processors handling an incoming signal; and,

FIG. 4 illustrates an exemplary computing platform which can be used in implementing the present embodiments.

### DETAILED DESCRIPTION

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is therefore not to be taken in a limiting sense, and the scope of the present invention is defined only by the appended claims and their equivalents.

Described hereinafter is a method by which incoming signals that need fast processing may be handled using multiple traditional processors which are connected in parallel to simultaneously handle portions of the incoming signal. By the use of the inventive method, OFDM based wireless modems can be implemented on traditional processors. Described hereinafter is a novel mechanism to parallelize the signal processing over multiple processors. The actual number of processors required depends on the capability of the processor as well as the OFDM waveform specification. As an example of how the guidelines described in this invention can be used, the implementation of IEEE standard “802.11a” is discussed below.

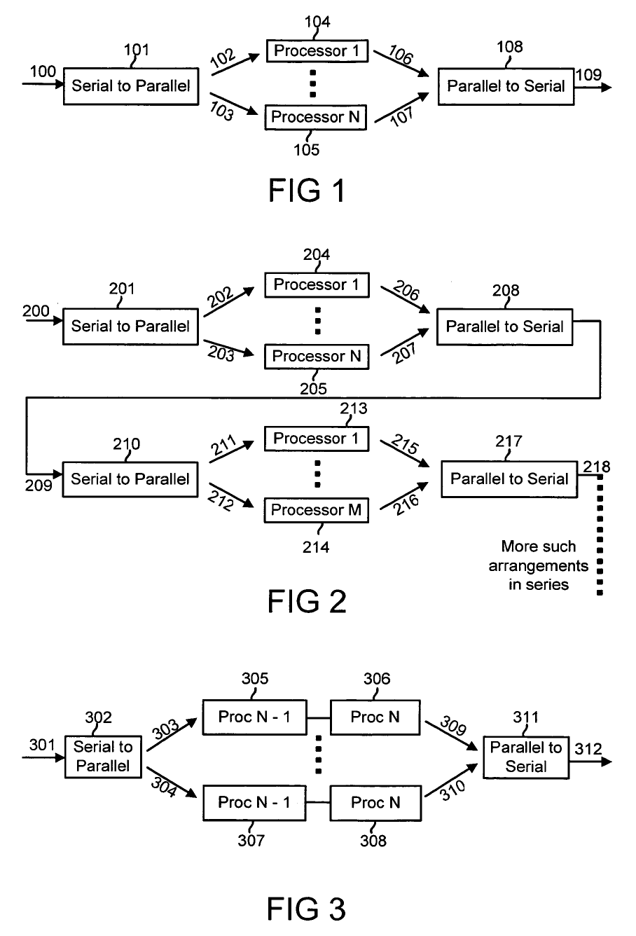

FIG. 1 illustrates four functional blocks, showing incoming signal 100 which may be OFDM based. The signal is processed in converter block 101 to be split into two signal components 102 and 103, which are processed respectively by parallel processors 104 and 105. It is understood that FIG. 1 shows two traditional processors to handle two signal components, but the number of parallel processor could be “N” to process the incoming signal if the signal were divided into “N” parts. The incoming signal comprises a set of symbols to be processed, where each said symbol needs, by design, to be processed in less than a first predetermined time interval, where, each available traditional processor needs more than said first predetermined time interval to process each said symbol. Using the scheme of FIG. 1, the signal is completely processed in a time interval that it takes to process only half of the total signal content. This way, traditional processors that might require more processing time because of their limited processing speed, could be put to use for handling signals which, for example need to be processed in a fraction of the time that a traditional processor alone needs, for processing the entire incoming signal. The step of splitting the signal 100 into two signal components could be accomplished by grouping the odd numbered symbols and even numbered symbols separately, as an example. Alternatively, the total number of symbols could be divided into two signal components in any other manner. The signal components processed by the processors 104 and 105 are identified as 106 and 107 respectively, and are combined into a single output 109 in the parallel-to-series converter box 108.

FIG. 2 illustrates an arrangement which contains two configurations similar to that in FIG. 1, but connected in series. FIG. 2 shows incoming signal 200 split into two signal components 202 and 203 in a serial-to-parallel converter box 201, and separately processed in traditional processors 204 and 205, to produce outputs 206 and 207 which are combined to provide the signal 209 from the parallel-to-serial box 208. Components/reference numerals 210 to 217 are to be understood as functioning similar to the counterparts in the first half portion of the FIG. 2 schematic. It is understood that more such configurations such as in FIG. 1 may be additionally connected in series with the arrangement shown in FIG. 2.

FIG. 3 illustrates another arrangement of multiple processors, showing an incoming signal 301, series-to-parallel block 302, signal components 303 and 304, series connected processors 305 and 306, 307 and 308, processed signals 309 and 310, parallel-to serial converter block 311 producing an output 312. The FIG. 3 configuration is similar to that in FIG. 1 except that instead of a single traditional processor handling each signal component, there are two traditional processors in series. As in FIG. 1, there could be several parallel branches between the two branches of parallel processors shown. More specifically, the following features are noted in connection with the embodiments illustrated in FIGS. 1-3: (1). The design of a multi processor implementation for OFDM based wireless modem has not been addressed in sufficient detail in literature.

(2) The main problem with implementation of OFDM based modems on processors is that if the processor is not fast enough, then it is not able to keep pace with the amount of processing that each OFDM symbol requires. The key idea in the present arrangements is to perform processing of different OFDM symbols simultaneously on different processors. This gives each processor more time to perform the operations required on each OFDM symbol.

(3) Since the described approach inherently parallelizes, a serial to parallel and parallel to serial conversion is required before and after this multi processor arrangement. This is shown in FIG. 1.

(4) For example, consider the case of “IEEE 802.11a” applied to an OFDM based wireless waveform specification. The standard requires that each single OFDM symbol should be processed every 4 us. Assume that a processor is capable of performing the operations required for modulation/demodulation of the IEEE 802.11a OFDM symbol only in 7.5 us. In this case, such a processor would not be capable of implementing the IEEE 802.11a waveform. However, using the guidelines provided above (#2 and #3), the OFDM symbol processing can be parallelized. This can be done by using two processors each of which is capable of doing the processing of one OFDM symbol in 7.5 us. Processor 1 processes all the odd numbered OFDM symbols while processor 2 processes all even numbered symbols. Initially the first processor starts processing. However since it takes 7.5 us, the second OFDM symbol is ready to be processed even before Processor 1 has finished the processing. Now processor 2 performs the processing on OFDM symbol 2. By this mechanism, a dual processor arrangement is shown to handle the processing requirements imposed by “IEEE 802.11a” specification where a single processor implementation was not possible.

(5) Further, in the arrangements described above, it can usually be ensured that no communication is required between the processors. This simplifies the implementation of such a design. This can be arranged by making both the processors do the computation of such common parameters independently. This computation may put an additional computational load on the processor but is more than compensated by the design simplifications that are achieved. For example in IEEE 802.11a waveform, the scrambling pattern for each OFDM symbol is dependent on the pattern used in the previous OFDM symbol. However since this is not dependent on the data in the previous OFDM symbol, processing can be independently completed in both the processors.

(6) Further, in the above described arrangements, there is a chance that some data which needs to be processed belongs to more than one OFDM symbol. In that situation, processing can be performed by either providing the required data to all the processors or by performing these types of operations in the serial to parallel (or parallel to serial) converters. Such an arrangement is shown in FIG. 2. It may be noted here than the second arrangement of processors (Processors 1 . . . M) may or may not reuse the processors (Processors 1 . . . N). FIG. 3 illustrates a possible use of multiple processors where each parallel processor branch has at least two series connected processors.

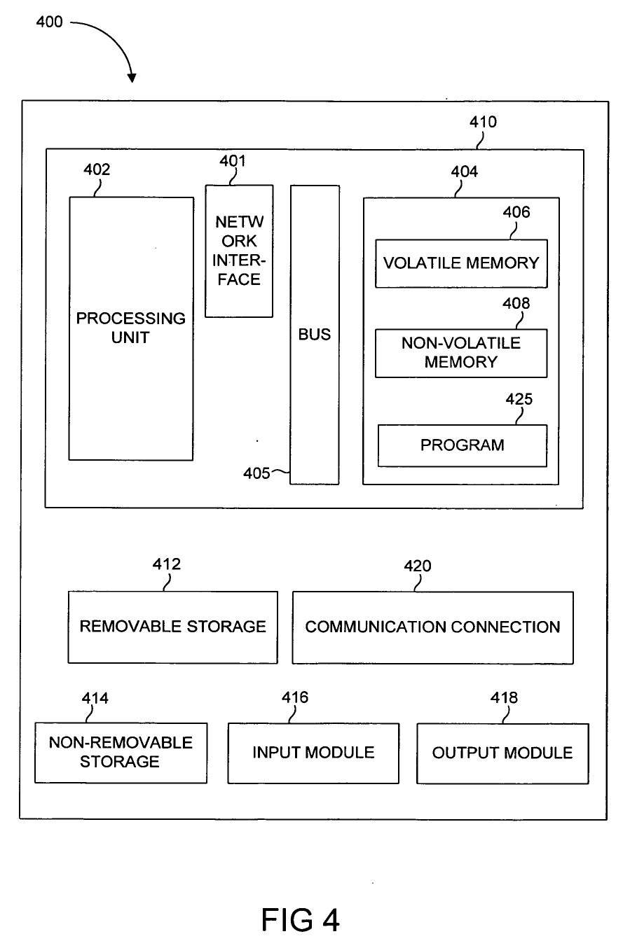

FIG. 4 shows an example of a suitable computing system environment for implementing embodiments of the present subject matter, especially as applied to 802.11 WLAN situations. FIG. 4 and the following discussion are intended to provide a brief, general description of a suitable processor/computing environment in which certain embodiments of the inventive concepts contained herein may be implemented. The method steps of dividing the incoming symbol stream into first and second streams and parallel-processing them and recombining them, can all be performed using an exemplary computing/processing platform as shown in FIG. 4. Other computing/processing platforms including processors with multiple internal execution paths may be used as well.

A general computing device in the form of a computer 410 may include a multiprocessing unit 402, memory 404, removable storage 412, and non-removable storage 414. Computer 410 additionally includes a bus 405 and a network interface (NI) 401.

Computer 410 may include or have access to a computing environment that includes one or more user input devices 416, one or more output modules or devices 418, and one or more communication connections 420 such as a network interface card or a USB connection. The one or more user input devices 416 can be a touch screen and a stylus and the like. The one or more output devices 418 can be a display device of computer, computer monitor, TV screen, plasma display, LCD display, display on a touch screen, display on an electronic tablet, and the like. The computer 410 may operate in a networked environment using the communication connection 420 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 404 may include volatile memory 406 and non-volatile memory 408. A variety of computer-readable media may be stored in and accessed from the memory elements of computer 410, such as volatile memory 406 and non-volatile memory 408, removable storage 401 and non-removable storage 414. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a multiprocessor unit, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit, including a processor with multiple internal execution paths. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 402 of the computer 410. For example, a computer program 425 may include machine-readable instructions capable of dividing an incoming signal into two or more signal streams as per requirements, according to the teachings of the described embodiments of the present subject matter. The incoming signal may be divided into two or more signal streams of equal or unequal size for being processed simultaneously by the parallel connected traditional processors. In one embodiment, the computer program 425 may be included on a CD-ROM and loaded from the CD-ROM to a hard drive in non-volatile memory 408. The machine-readable instructions cause the computer 410 to assist signal handling according to the various embodiments of the present subject matter.

The foregoing is the description of exemplary implementations of the method and an article for multiprocessor implementation for processing signals that need faster processing than what traditional processors are generally capable of. The above implementations are described in the context of OFDM based wireless modems as an example, but are intended to be applicable, without limitation, to situations where fast processing of signals is needed, and where the speed of available processing means falls short of the need. The description hereinabove is intended to be illustrative, and not restrictive.

The various embodiments of the parallel processing system described hereinabove are applicable generally to any signal processing system where the processing speed is critical and, traditional processors do not cater to the required processing speed. The embodiments described herein are exemplary only and in no way intended to limit the applicability of the invention. In addition, the techniques of the various exemplary embodiments are useful to the design of any hardware implementations of software, firmware, and algorithms in the context of signal processing in general. Many other embodiments will be apparent to those skilled in the art. The scope of this invention should therefore be determined by the appended claims as supported by the text, along with the full scope of equivalents to which such claims are entitled.

1. A method of processing data received as a signal comprising a set of symbols to be processed, where each said symbol needs, by design, to be processed in less than a first predetermined time interval, where, available processing means needs more than said first predetermined time interval to process each said symbol, said method comprising the steps of:
dividing said set of symbols to be processed into a plurality of symbol groups;
using parallel processing paths containing at least as many parallel paths as there are symbol groups;
routing each said symbol group for processing, into one of said parallel processing paths; and,
combining outputs from said parallel processing paths to form an output signal of processed data.

2. The method as in claim 1, wherein said plurality of symbol groups is two in number, a first symbol group containing odd numbered symbols, and a second symbol group containing even numbered symbols, wherein the step of using parallel processing paths comprises using two parallel paths.

3. The method as in claim 1, wherein said symbols in said signal comprise orthogonal frequency division multiplexing (OFDM) symbols.

4. The method as in claim 1, implemented in a wireless local area network (WLAN) scenario.

5. The method as in claim 1, implemented in “IEEE 802.11a” scenario.

6. The method as in claim 1, wherein said first and second processors have equal processing speeds.

7. The method as in claim 1, including the step of processing said odd and even numbered symbols independently, without the first and second processors directly interacting with each other.

8. The method as in claim 2, wherein said data belongs to more than one set of OFDM symbols, said method including the step of doing the processing by connecting at least a third processor in series with said first processor.

9. The method as in claim 8, including the step of connecting a fourth processor in series with said second processor, forming a first four-processor arrangement.

10. The method as in claim 9, including the step of connecting a second four processor arrangement in series with said first four-processor arrangement.

11. A method of processing data in the form of a signal containing a set of symbols, where each said symbol needs to be processed in less than “n” microseconds, by design, where processing means that is available can process each said symbol in greater than “n” microseconds, said method comprising the steps of:
dividing said signal for processing purposes into first and second streams, said first stream containing odd numbered symbols from said signal, said second stream containing even numbered symbols from said signal;
using at least first and second processors connected in parallel, said first and second processors forming part of said processing means;
processing said odd numbered symbols in said first processor, and simultaneously processing said even numbered symbols in said second processor; and,
combining said processed odd and even numbered symbols to result in a processed data signal.

12. The method as in claim 11, wherein said symbols in said signal comprise orthogonal frequency division multiplexing (OFDM) symbols.

13. The method as in claim 11, implemented in a wireless local area network (WLAN) scenario.

14. The method as in claim 11, implemented in “IEEE 802.11a” scenario.

15. The method as in claim 11, wherein said first and second processors have equal processing speeds.

16. The method as claim 11, including the step of processing said odd and even numbered symbols independently, without the first and second processors directly interacting with each other.

17. The method as in claim 12, wherein said data belongs to more than one set of OFDM symbols, said method including the step of doing the processing by connecting at least a third processor in series with said first processor.

18. The method as in claim 17, including the step of connecting a fourth processor in series with said second processor, forming a first four-processor arrangement.

19. The method as in claim 18, including the step of connecting a second four processor arrangement in series with said first four-processor arrangement.

20. The method as in claim 12, wherein data contents in one OFDM symbol are not dependent on data in a previous OFDM symbol.

21. An article comprising a storage medium having instructions thereon, which when executed by a computing platform result in a method of processing data received as a signal comprising a set of symbols to be processed, where each said symbol needs, by design, to be processed in less than a first predetermined time interval, where, available processing means needs more than said first predetermined time interval to process each said symbol, said method comprising the steps of:
dividing said set of symbols to be processed into a plurality of symbol groups;
using parallel processing paths containing at least as many parallel paths as there are symbol groups;
routing each said symbol group for processing, into one of said parallel processing paths; and,
combining outputs from said parallel processing paths to form an output signal of processed data.

22. The article as in claim 21, wherein said symbols in said signal comprise orthogonal frequency division multiplexing (OFDM) symbols.

23. The article as in claim 21, wherein said method is implemented in “IEEE 802.11a” scenario.

24. An article comprising a storage medium having instructions thereon, which when executed by a computing platform result in a method of processing data in the form of a signal containing a set of symbols, where each said symbol needs to be processed in less than “n” microseconds, by design, where processing means that is available can process each said symbol in greater than “n” microseconds, said method comprising the steps of:
dividing said signal for processing purposes into first and second streams, said first stream containing odd numbered symbols from said signal, said second stream containing even numbered symbols from said signal;
using at least first and second processors connected in parallel, said first and second processors forming part of said processing means;
processing said odd numbered symbols in said first processor, and simultaneously processing said even numbered symbols in said second processor; and,
combining said processed odd and even numbered symbols to result in a processed data signal.

25. The article as in clam 24, wherein said symbols in said signal comprise orthogonal frequency division multiplexing (OFDM) symbols.

26. The article as in claim 24, wherein said method is implemented in “IEEE 802.11a” scenario.
